(19) United States
(12) Patent Application Publication
(10) Pub. No.: US 2011/0056056 A1
(43) Pub. Date: Mar. 10, 2011

(54) COMPONENT ADAPTED FOR HANDS-FREE ASSEMBLY TO A PANEL, A COMPONENT AND PANEL ASSEMBLY AND A METHOD FOR ASSEMBLING A COMPONENT TO A PANEL

(75) Inventors: Dirk TIEMANN, Orbis (DE); Peter KAHLER, Nierstein (DE)

(73) Assignee: GM GLOBAL TECHNOLOGY OPERATIONS, INC., Detroit, MI (US)

(21) Appl. No.: 12/557,274

(22) Filed: Sep. 10, 2009

(51) Int. Cl. A44B 13/00; B23P 11/00; B21D 53/88

(52) U.S. Cl. 24/592.11; 24/592.1; 29/428; 29/897.2

(57) ABSTRACT

A component, a component and panel assembly, and a method are provided is adapted for hands-free assembly. A component is provided that is adapted for hands-free assembly to a panel at a desired location. The component includes, but is not limited to a body and at least one retainer member extending outwardly from the body a predetermined distance and adapted to be received in an aperture in the panel. The retainer member is adapted to temporarily hold the component on the panel before final assembly and has the form of a hook.

### TECHNICAL FIELD

The present application relates to a component adapted for hands-free assembly to a panel, for example an automotive component adapted for hands-free assembly to a vertical automotive body panel, a component and panel assembly and a method for assembling a component to a panel.

### BACKGROUND

When assembling a component to a panel, in particular a vertical panel, the component has to be held in place in the desired installation location whilst the component is being secured to the panel by fastening means such as screws. If the component is held in place by the operator, the component may be dropped or misaligned by the operator.

To overcome these problems among others, U.S. Pat. No. 7,367,610 B2 discloses a component which can be temporarily coupled to the panel so that the operator's hands are free to retrieve a fastening tool, to fasten the component to the panel and perform any other desired tasks. In particular, the component includes three fasteners, each with a head, which is adapted to be received in an aperture in the panel and adapted to temporarily hold the component to the panel. The operator can then tighten the fasteners to finally fix the component to the panel without having to hold the component in the desired position. The arrangement, therefore, allows the hands-free final assembly of the component to the panel.

However, this solution has the disadvantage that the spatial positioning of the threaded fasteners in the component is limited since the threaded fasteners have to be both attached to the component and be accessible to allow them to be tightened whilst the component is temporarily coupled to the panel. The types of component for which this arrangement can be used are limited.

Therefore, it is desirable to provide a component as well as a component and panel assembly and method of assembling a component to a panel that are suitable for use for a wider range of components. In addition, other desirabilities will become apparent from the subsequent detailed description of the invention and the appended claims, taken in conjunction with the accompanying drawings and this background

### SUMMARY

The application provides a component adapted for hands-free assembly to a panel at a desired location that comprises a body and at least one retainer member. The retainer member extends outwardly from the body a predetermined distance and is adapted to be received in an aperture in the panel and to temporarily hold the component on the panel before final assembly. The retainer member has the form of a hook.

The retainer member is used solely to temporarily hold the component on the panel before and during final assembly of the component to the panel. The retainer member or members do not have to accessible to the operator after temporarily coupling the component to the panel since their function is complete. Therefore, the retainer members can positioned more freely on the body than would be the case if they had to be accessible to the operator after the component is temporarily adapted to the panel.

The retainer member in the form of a hook has the advantage that it is simple to fabricate and simple to insert into an aperture in the panel so that production costs and assembly costs are kept low.

In particular, the component may be temporarily held or coupled to a vertical or near vertical panel or a vertical or near vertical portion of a panel. Therefore, the component can be used for applications in which the panel cannot be moved into a horizontal position in order to temporarily couple the component to the panel by the use of gravity.

In one embodiment, the component is a component of a vehicle and the panel is a body panel of vehicle. The component of the vehicle may be an interior trim panel or an additional part of the chassis which is later welded to the body panel.

In an embodiment, the retainer member is bent such that a base portion of the retainer member extends outwardly from the body of the component and a distal end of the retainer member extends orthogonally to the base portion. The distal end may extend upwardly or downwardly from the base portion when the component is coupled to the panel. The hook may have a strip-like form which is generally L-shaped.

These embodiments have the advantage that the retainer member retainer member in the form of a hook is simple to manufacture from a plate or foil or strip of the desired material.

In a further embodiment, the retainer member is bent such that a base portion of the retainer member extends generally parallel to the body, a central portion of the retainer member extends outwardly from the body and a distal end of the retainer member extends generally parallel to the body. The base portion may lie free from the body, for example, it may extend within an aperture that is larger than the strip. This arrangement provides additional movement of the retainer member in directions orthogonal to the body of the component which can be used to compensate for size differences in these directions and allow the component to be fitted flush with the surface of the panel.

The retainer member may be provided as a separate piece which is fixedly attached to the body. Alternatively, the retainer member may be provided by a portion of the body. For example, a flap may be cut in a rear surface of the body of the component and bent so that it extends outwardly from the body.

The retainer member can extend from various parts of the body of the component. In one embodiment, the retainer member extends from a central portion of a rear side of the body. In other words, the retainer member is not positioned in peripheral regions of the body of the component. After the component is coupled to the panel it is hidden from view since it is positioned behind the portion of the panel directly behind the component. This enables the fastening devices to be placed in aesthetically pleasing positions, for example, since the temporary coupling function is performed by the retainer members which are hidden from view.

The number of retainer members can be adapted to the size and form of the component and the panel. Larger components may be provided with two or more retainer members that are spaced apart from one another. In one embodiment, two retainer members are provided which are arranged on a common horizontal line of the body. In a further embodiment, three retainer members are provided which may have a triangular arrangement.

The component may also comprise fastening means with which the component can be fastened to the panel. The fastening means may have the form of one or more holes through which a screw of bolt may be inserted to attach the component to the panel. The fastening means may also be a screw or a bolt which extend from the component.

The application also provides a component and panel assembly. The component comprises a body comprising at least one retainer member in the form of a hook according to one of the previous embodiments. The panel has at least one L-shaped aperture with a vertical portion and a transverse portion. The transverse portion is smaller than the vertical portion. The vertical portion is adapted to receive the retainer member so that the retainer member can be inserted in and through the aperture.

If two or more retainer members are provided the panel comprises an equivalent number of apertures having an arrangement adapted to receive the arrangement of the retainer members of the body.

Independent of the number of retainer members and apertures, the retainer member and the aperture are adapted to one another so as to allow the component to be temporarily held on the panel. At least during assembly of the component on the panel, the portion of the panel onto which the component is assembled may be generally vertical or at an angle such that if the retainer members were omitted, the components would fall from the panel due to the effects of gravity.

In an embodiment, the retainer member comprises a base portion extending orthogonally from a rear side of the body and a distal portion extending parallel to the rear side of the body. The vertical portion of the L-shaped aperture is adapted to receive the distal portion of the retainer member so as to allow the retainer member to be inserted through the aperture. The distal portion is then positioned on the opposing side of the panel to the body of the component.

In a further embodiment, the transverse portion of the aperture is adapted to receive the base portion of the retainer member. If the retainer member has the form of a strip, then the transverse portion of the aperture has a height and a width adapted to receive the thickness and width of the base portion of the strip. When the component is temporarily coupled to the panel, the base portion may extend through the transverse portion with the distal portion positioned adjacent the transverse portion on the opposing side of the panel from the body of the component. The vertical portion of the aperture may be unoccupied by the retainer member.

In an embodiment, the component comprises two or more retainer members and the panel comprises two or more apertures. The retainer members and apertures are, in each case, adapted to accommodate one another. For example, the L-shaped form of the apertures are arranged in the panel such that the vertical portions are parallel to one another and the transverse portions all extend in the same direction from the vertical portions.

The application also provides a method of assembling a component to a panel at a desired location. The method comprises first temporarily coupling the component to the panel before hands-free finally attaching the component to the panel (i.e., finally attaching the component to the panel without holding the component on the panel).

Too temporarily couple the component to the panel, at least one retainer member extending outwardly from a body of the component is inserted a predetermined distance into and through an aperture in the panel. The component is then moved transversely to the direction of insertion so that the retainer member protrudes through a narrower portion of the aperture so as to temporarily hold the component on the panel for hands-free final assembly. The component is then mounted on the panel by attaching the component to the panel by at least one additional fastening device arranged separately from the at least one retainer member whilst it is coupled to the panel by the retainer member.

The component may be mounted on the panel by at least one additional fastening device in the form of a screw or a nut and bolt or a welded joint.

In an embodiment, the retainer member comprises a base portion extending orthogonally from a rear side of the component and a distal portion extending parallel to the rear side of the component. The retainer member, in particular the distal portion and at least a part of the base portion, is inserted through the aperture and the retainer member moved transversely to the direction of insertion so that the base portion protrudes through the narrower portion of the aperture. The distal end of the retainer member and the body of the component are positioned on opposing sides of the panel to temporarily hold the component on the panel for hands-free final assembly since the distal end cannot fit through the narrower transverse portion of the aperture.

The method may be used to assemble an automotive component to an automotive body panel, in particular an automotive body panel which is generally vertical. The automotive component may be a further a chassis part, an interior trim part, such as a trim panel, or a further component such as a speaker, rear view mirror and so on.

### BRIEF DESCRIPTION OF THE DRAWINGS

The present invention will hereinafter be described in conjunction with the following drawing figures, wherein like numerals denote like elements, and.

FIG. 1 illustrates a rear side of a panel onto which a component is to be assembled;

FIG. 2 illustrates the insertion of a retainer member extending from the component through the apertures in the panel;

FIG. 3 illustrates the retainer member extending through the aperture in the panel; and

FIG. 4 illustrates the coupling of the component to the panel by the transverse movement of the retainer member within the aperture.

### DETAILED DESCRIPTION

The following detailed description is merely exemplary in nature and is not intended to limit application and uses. Furthermore, there is no intention to be bound by any theory presented in the preceding background or summary or the following detailed description.

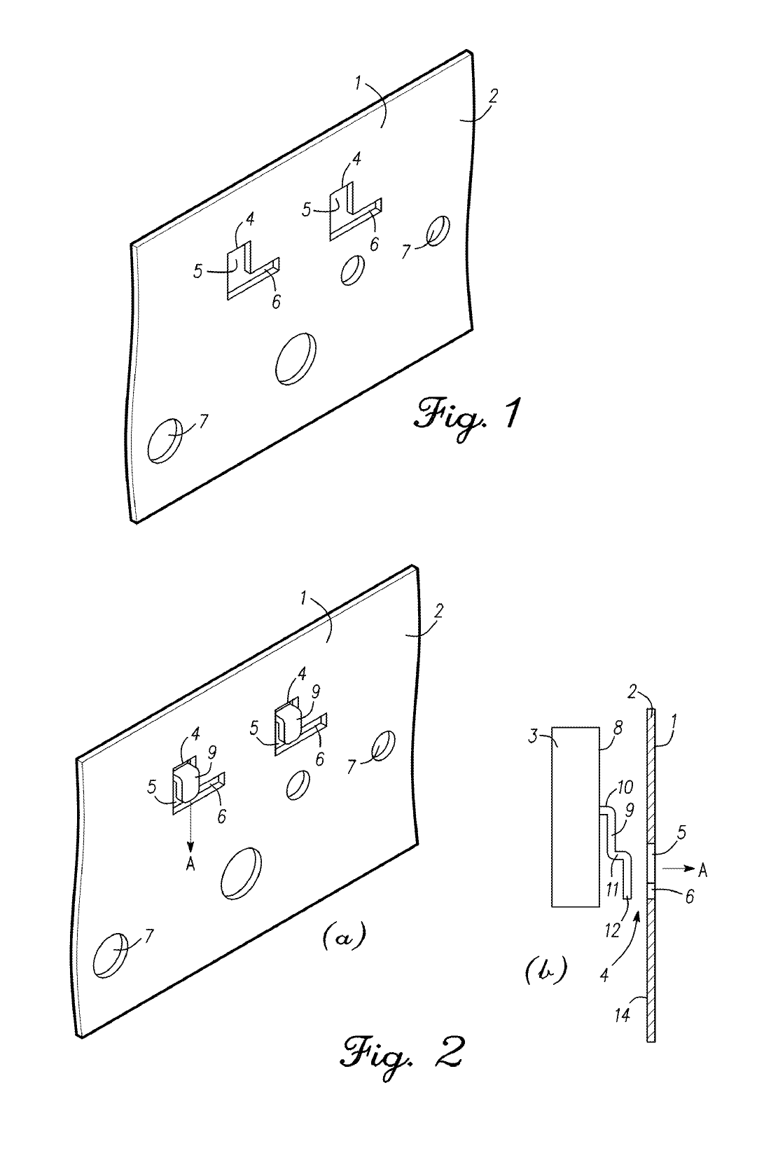

FIG. 1 illustrates a portion of a rear side 1 of a panel 2 onto which a component 3 that is not illustrated in FIG. 1 is to be assembled. In this particular embodiment, the panel 2 is a body panel of an automotive vehicle, which is positioned vertically, and the component 3 is an interior trim panel.

The panel 2 comprises two L-shaped apertures 4 aligned with one another in a horizontal plane and spaced at a distance from one another. Each L-shaped aperture 4 has a vertical portion 5 extending into a transverse portion 6. The transverse portion 6 has a smaller height than the vertical portion 5. The L-shaped apertures 4 are arranged and adapted to receive to retainer members extending from the component 3 which is to be assembled onto the non-illustrated front side of the panel 2. The panel 2 also comprises additional apertures 7 which are arranged in the panel 2 and adapted to receive fastening means to finally assemble the component 3 to the panel 2.

As illustrated in FIG. 2b, the component 3 has a body 8 with a rear side 15 which is to be mounted onto the front side 14 of the panel 2. The rear side 15 of the component comprises two retainer members 9 which are arranged in the central regions of the rear side 15 of the body 8 of the component 3. Each retainer member 9 has the form of a hook which is adapted to be inserted into one of the L-shaped apertures 4 arranged in the panel 2.

In particular, each retainer member 9 has a base portion 10 which extends generally parallel to the rear side 15 of the component 3. The base portion 10 extends into a central portion 11 which extends generally orthogonally away from the rear side 15 of the component 3 and then further extends into a distal portion 12 which extends parallel to the rear side 15 of the component 3. In particular, the distal portion 12 extends downwardly, whereby downwardly refers to its direction when the component 3 is installed in the desired installation location on the panel 2.

FIG. 2a and FIG. 2b illustrate that the distal portion 12 of the retainer member 9 is able to be inserted through the vertical portion 5 of the L-shaped apertures 4 in direction A which is generally orthogonal to the plane of the panel 2. The vertical portion 5 has an area which is greater than the lateral size of the distal portion 12 of the retainer member 9. As illustrated in FIG. 2a, one of the two retainer members 9 is inserted into each of the apertures 4 generally simultaneously in direction A. Therefore, the spacing of the retainer members 9 is adapted to the spacing of the L-shaped apertures 4 of the panel 2 and vice versa.

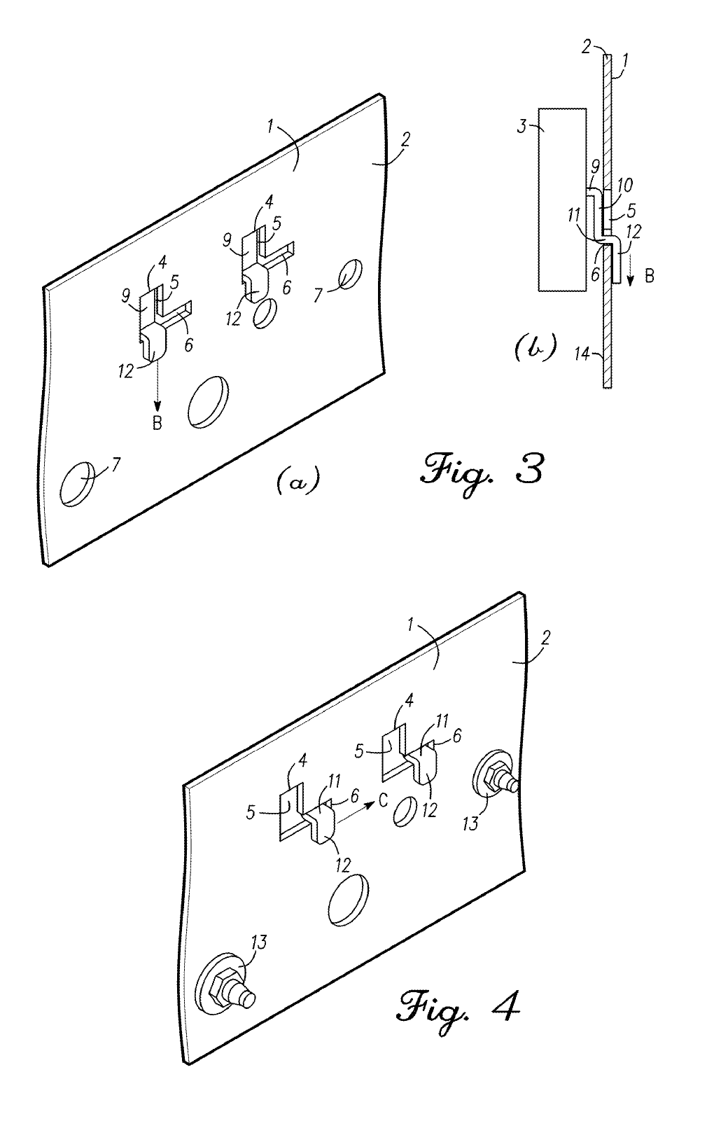

FIG. 3a and FIG. 3b illustrate a further stage in the temporary coupling of the component 3 to the panel 2 by means of the retainer members 9 protruding from the rear side 15 of the component 3. After the distal portions 12 of the retainer members 9 are inserted through the vertical portion 5 of the apertures 4 in direction A, the component is lowered in direction B so that the distal portion 12 is positioned on the rear side 1 of the panel 2 and so that it extends below the lowermost edge of the aperture 4.

FIG. 4 illustrates further stage in the temporary coupling of the component 3 to the panel 2. After the distal portions 12 of the retainer member 9 are arranged on the rear side 1 of the panel 2, the component 3 is moved transversely in direction C so that the generally horizontal central portion 11 of the retainer member 9 extends through the transverse portion 6 of the L-shaped apertures 4. The height of the transverse portion 6 is adapted to accommodate the thickness of the strip like retainer member 9.

The distal portion 12 of the retainer member 9 is now positioned below the transverse portion 6 of the aperture 4. Since the transverse portion 6 of the aperture 4 is smaller than the height of the distal portion 12, when the operator lets go of the component 3, the component 3 hangs on the panel 2 due to the positioning of the retainer member 9 in the transverse portion 6 of the aperture 4.

Since the distal portion 12 is larger than the transverse portion 6 of the aperture 4, the weight of the component 3 cannot pull the distal portion 12 of the retainer member 9 through the transverse portion 6 of the aperture. The component 3 is now temporarily coupled to the panel 2 in a hands-free manner so that the operator can attach the component 3 to the panel 2 without holding the component 3 in position.

As is also illustrated in FIG. 4, the component 3 is the finally attached to the panel 2 by means of two additional nut and bolt connections which are positioned in the additional apertures 7 provided in the panel 2. Therefore, the retainer members 9, which temporary couple the component 3 to the panel 2 and allow hands-free final assembly of the component 3 onto the panel 2, are separate from the fastening means 13 by which the component 3 is finally assembled onto the panel 2.

The retainer members 9 are hidden from view on the front side 14 of the panel 2 by the rear side 15 of the component 3 since they extend from a central portion of the rear side 15 of the component 3.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A component adapted for hands-free assembly to a panel at a desired location, comprising:
a body; and
a retainer member in a form of a hook that extends outwardly from the body at a predetermined distance and adapted to be received in an aperture in the panel, the retainer member being adapted to temporarily hold the component on the panel before final assembly.

2. The component according to claim 1, wherein the retainer member is bent such that a base portion of the retainer member extends outwardly from the body and a distal end of the retainer member extends orthogonally to the base portion.

3. The component according to claim 1, wherein the retainer member is bent such that a base portion of the retainer member extends parallel to the body, a central portion of the retainer member extends outwardly from the body and a distal end of the retainer member extends parallel to the body.

4. The component according to claim 1, wherein the retainer member is fixedly attached to the body.

5. The component according to claim 1, wherein the retainer member is a portion of the body.

6. The component according to claim 1, wherein the retainer member extends from a central portion of a rear side of the body.

7. The component according to claim 1, wherein the component comprises at least two retainer members.

8. A component and a panel assembly, comprising:
a body comprising a retainer member, the retainer member having a form of a hook and extending outwardly from the body at a predetermined distance and being adapted to be received in an aperture and to temporarily hold the component; and
a panel having an L-shaped aperture with a vertical portion and a transverse portion, the transverse portion being smaller than the vertical portion and the vertical portion being adapted to receive the retainer member.

9. The component and panel assembly according to claim 8, wherein the retainer member comprises a base portion extending orthogonally from a rear side of the body and a distal portion extending parallel to the rear side of the body.

10. The component and panel assembly according to claim 9, wherein the vertical portion of the aperture is adapted to receive the distal portion of the retainer member.

11. The component and panel assembly according to claim 9, wherein the transverse portion of the aperture is adapted to receive the base portion of the retainer member.

12. The component and panel assembly according to claim 9, comprising at least two more retainer members and at least two more apertures.

13. A method of assembling a component to a panel at a desired location, the method comprising:
inserting a retainer member extending outwardly from a body of the component in a predetermined distance into and through an aperture in the panel;
moving the component transversely to a direction of insertion so that the retainer member protrudes through a narrower portion of the aperture to temporarily hold the component on the panel for hands-free final assembly; and
mounting the component on the panel by attaching the component to the panel by an additional fastening device arranged separately from the retainer member.

14. The method of claim 13, wherein the mounting of the component on the panel is performed with at least one additional fastening device.

15. The method of claim 13, wherein the retainer member comprises a base portion extending orthogonally from a rear side of the component and a distal portion extending parallel to the rear side of the component, the retainer member being inserted through the aperture and moved transversely to the direction of insertion so that the base portion protrudes through the narrower portion of the aperture and a distal end and the body of the component are positioned on opposing sides of the panel to temporarily hold the component on the panel for hands-free final assembly.
